(19) United States
(12) Patent Application Publication
(10) Pub. No.: US 2014/0380191 A1
(43) Pub. Date: Dec. 25, 2014

(54) METHOD AND APPARATUS FOR DESIGN REVIEW COLLABORATION ACROSS MULTIPLE PLATFORMS

(71) Applicant: Autodesk, Inc., San Rafael, CA (US)

(72) Inventors: Ilai Rotbaein, Tel Aviv (IL); Jonathan Mesh, (US); Jonathan Seroussi, Tel Aviv (IL); David Wayne Arsenault, San Francisco, CA (US)

(21) Appl. No.: 13/925,475

(22) Filed: Jun. 24, 2013

(51) Int. Cl. H04L 29/06

(52) U.S. Cl. CPC H04L 65/403
USPC 715/753

(57) ABSTRACT

A method, apparatus, system, and computer program product provide the ability to comment on a graphic design. A graphic design is obtained. A comment is accepted from an author commenting on the graphic design. The comment includes contextual metadata. The contextual metadata provides an identification of a location in the graphic design, a date and time the comment was accepted, an author identification, and searchable text. The comment is then displayed.

### BACKGROUND OF THE INVENTION

1. Field of the Invention

The present invention relates generally to drawing/graphic design applications, and in particular, to a method, apparatus, and article of manufacture for design review collaboration across multiple platforms.

2. Description of the Related Art

One of the common design collaboration workflows is known as a “markup.” Today, a markup is largely unchanged from the paper-based workflows that were pervasive at one time. The problem with the traditional method is that there is real information locked in the markup that cannot be leveraged for other purposes. To better understand such problems, a more detailed description of prior art markups and techniques may be useful.

The traditional method, in computer aided design (CAD)/graphic design systems, for providing review/feedback of a drawing/design/model is to print the drawing/design/model on paper and use a pen (e.g., a red pen) to markup the printout with questions, comments, or details. Special symbols would often be used to imply purpose (e.g., new paragraph, delete work, insert new words, etc.). The paper may then be scanned in or manually provided to the appropriate recipient for further analysis/review. Once a user resorts to the use of manual (e.g., via a pen) handwritten markups, critical information is lost that might be useful to whatever project the user is working on later. There is no mechanism that takes advantage of some of this information when the markup is hand written on paper. For example, it would be useful to have the capability to search the markups based on search criteria such as author, date/time, associated object, etc.

Accordingly, what is needed is a capability to provide review/feedback of a digital design/drawing while maintaining the ability to search such review/feedback based on a variety of search criteria.

### SUMMARY OF THE INVENTION

Embodiments of the invention overcome the problems of the prior art by separating out the graphics of a comment from contextual information/metadata about the comment. Contextual information/metadata regarding the comment is extracted/extrapolated (e.g., in real-time dynamically) when a comment is created by a user and stored in a database. The database is searchable and permits downstream workflows that enable design review collaboration across multiple computer platforms (e.g., mobile, tablet, laptop, desktop, etc.).

The contextual information/metadata associated with a comment includes an identification of a location in a graphic design/drawing, a date and time the comment was created/accepted, an author identification, and searchable text. In addition to the above standard contextual information/metadata, enhanced contextual information/metadata includes view information (regarding the view of the drawing at the time the comment was entered) that enables the restoration of the view for any subsequent comment viewers. Such a restoration may be performed in both a two dimensional (2D) and three-dimensional (3D) context/environment.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the workflow for commenting on a drawing in accordance with one or more embodiments of the invention; and

FIG. 4 illustrates the logical flow for comment on a graphic design in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention provide for the concept of a “comment” that contains more contextual information/metadata than an unstructured set of graphics. The contextual metadata includes date, time, author, and search text and can optionally include view information (so that a view of the drawing at the time a comment was inserted can be restored/viewed). Further, a comment may be associated with particular objects in a drawing (where such objects are identified in the contextual metadata). To enable a search to be performed across all comments/drawings/projects, contextual data may be stored in a database that is accessible to all users (or a secure set of users) (e.g., on the cloud). Users may also have the capability to respond and reply to comments thereby providing a mechanism for collaborative review and resolution with respect to drawing design issues.

### Hardware Environment

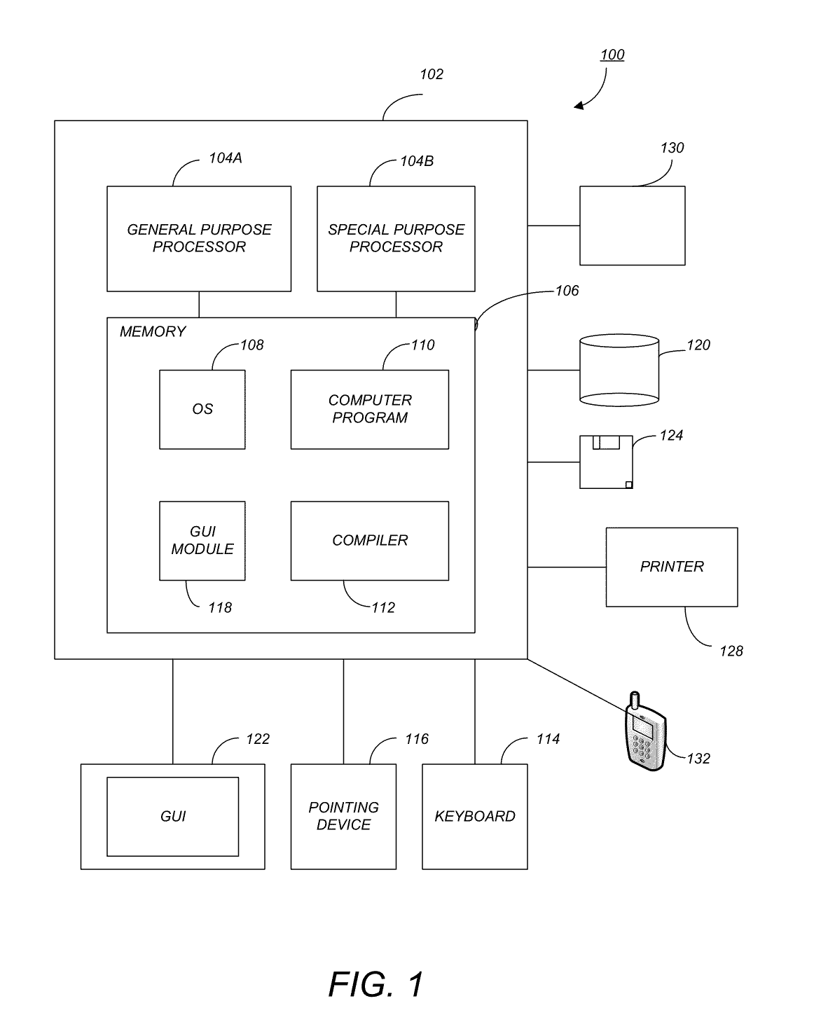

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

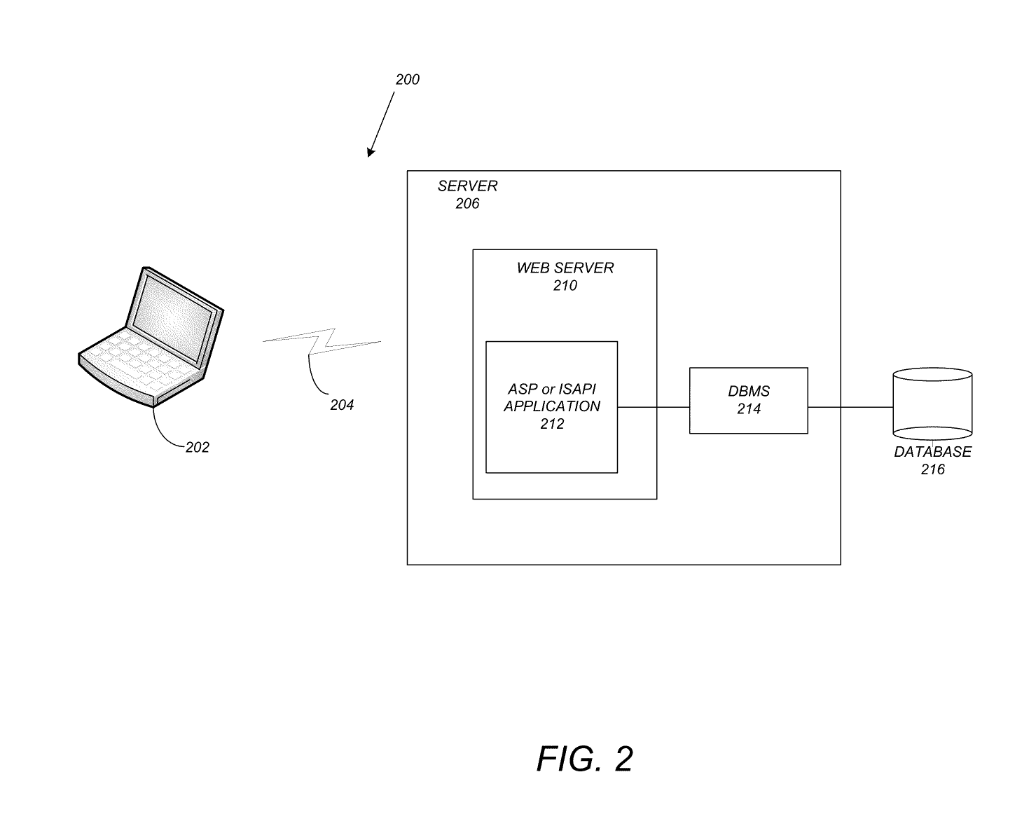

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 202 may be downloaded from server computer 206 to client computers 202 and installed as a plug-in or ACTIVEX™ control of a web browser. Accordingly, clients 202 may utilize ACTIVEX™ components/component object model (COM) or distributed COM (DCOM) components to provide a user interface on a display of client 202. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 202 and 206.

### Software Embodiment Overview

Embodiments of the invention are implemented as a software application on a client 202 or server computer 206. Further, as described above, the client 202 or server computer 206 may comprise a thin client device or a portable device that has a multi-touch-based display.

In one or more embodiments of the invention, the software application comprises a computer/graphic design application that is configured with a “comment” feature. The comment feature provides for the creation of a comment consisting of review/feedback about the graphic design. Such a comment may consist of freehand graphics, structured graphic (e.g., a circle/line using a circle/line function), text, etc. As the comment is created, contextual information/metadata for the comment is captured. Thus, the comment consists of more than merely an unstructured set of graphics. The contextual information/metadata includes an identification of a location in the graphic design, a date and time the comment is accepted/input, an author identification, and searchable text. As the identification of the location in the graphic design (e.g., the specific object and/or area of the drawing is identified in the metadata), there is no ambiguity regarding which part/object/drawing area/etc. a comment is associated with.

The contextual information/metadata is captured/stored (e.g., separately) in a database (e.g., database 120) that can be queried to find/retrieve a set of comments based on various search criteria. Thus, while the prior art fails to provide a searchable location for markups, embodiments of the present invention utilize a database (e.g., a master database) that stores all contextual information in a searchable manner. The invention is not limited to any particular type of database and may be implemented in one or more database types/configurations (e.g., a relational database, a cloud database, a distributed database, a graph database, etc.).

With respect to the searchable text, the comment inserted by an author/user may be automatically (by the comment application) converted into a textual representation that is stored in the database. For example, if a graphic/object/part is selected by a user, any text identification of that object (e.g., within the system/part database) may be utilized as the textual metadata. Optical character recognition may also be used to convert any image into associated text stored as part of the metadata. Alternatively, the text may be inserted by the author/user of the comment. For example, a text input box may be available and the author may insert text and use a pen to insert associated graphical information. As another example, suppose a user desires to make a comment about a particular part of an assembly model. The user may select/click on the part, type in the desired text (e.g., “wrong part to use here and part xyz should be used instead”). The metadata consists of both an identification of the selected part as well as the user inserted text. Thereafter, whenever the comment is selected, the part may be highlighted and vice versa. In addition (or alternatively), the comment (or an indication of the existence of an associated comment) may be saved with the part/object.

The metadata across one drawing, multiple drawings, one project, and or multiple projects may all be stored in a single database. Once stored in the database, the metadata is searchable to provide enhanced functionality to the user. In this regard, at any point in time subsequent to the creation and storage of the comment (and associated metadata), the database may be searched for such text, for the part/object associated with the comment, by date of entry of the comment, etc.

Examples of searches include finding all comments entered by a specific individual (e.g., across one drawing, multiple drawings, one project, multiple projects, etc.), finding all comments about a specific design entity/object, finding all designs with comments that contain a specific set of words, finding all comments from today, etc.

While the searches identified above provide some contextual (e.g., author, object, text, date/time) searching, embodiments of the invention may expand the contextual information/metadata to optionally include view information (so that a view can be restored), an image of what the design looked like at the precise time when a comment is made/inserted/created/accepted. In this regard, the view information may include camera settings, origin, camera position (e.g., within three-dimensional [3D] space), etc. which enables the restoration and/or display of the exact view that a user was looking at when the comment and/or replies were inserted. In this manner, when a future user is examining a comment, the original view is available to provide the future user with the context in which the comment was created.

Further contextual information/metadata may include a list of object identifiers so that the comment is bound to specific design elements, free hand graphics to add precision to the comment (and to provide some backward compatibility with older data, and other media (e.g., a photograph), etc. When including a list of object identifiers, such object identifiers may be linked across systems/applications such that the same/similar objects have the same identifiers regardless of the application/system. In other words, if a user creates a comment on a particular object in a CAD drawing in a CAD application, such an object identifiers may also be dynamically associated back with a model in a 3D modeling application. Consequently, object identifiers are linked across systems/applications so that metadata can be transported across systems and the comments can be tracked/utilized by different users in different applications (e.g., that may all be working on the same project).

To add yet additional functionality and to streamline the workflow process, embodiments of the invention may associate with/provide (e.g., in real time dynamically as the comment is created/inserted/accepted) the comment as part of an “activity stream”. As used herein, an activity stream is a mechanism for storing all activity about a particular object/drawing (e.g., when an object/drawing is downloaded, modified, who performed the edit, etc.). An activity stream may be stored/accessible in the cloud. Thus, if a user accesses a particular object/drawing, the activity stream for that object/drawing may be viewed by other users on any type of device (mobile, desktop, or otherwise) (via the cloud). In this regard, the same activity stream may be utilized across all applications that access the object.

By adding a comment to the activity stream, users such as field workers (on a tablet device) may access the same comment as a CAD designer (working on a particular CAD drawing on a desktop computer). Accordingly, as a comment is created/inserted, the comment is associated with a particular object or drawing (e.g., the original drawing) and has the same spatial context that other users have access to. Thus, a user can comment on a point, object, or region within a model/drawing and then have a conversation relating to comment as part of the activity stream. In addition, the user can attach various types of objects/entities to the comment including text, photographs, audio, video, files, hyperlinks, tasks, etc. When attaching a task, such a task may be assigned to a particular user/group of users (e.g., on one or more different platforms/systems) and resolution of the task may be tracked. Such an activity stream streamlines the end-to-end workflow from design to review (e.g., review can take place on the web or a mobile device) and all data is saved in a database to provide feedback and enrich the workflow.

By associating/saving a comment with an activity stream, a mechanism for collaborative review and resolution is provided. More specifically, the comment may from a thread with the ability for users to reply to a comment, and other users may respond thereto. The entire thread is associated with a particular comment that is associated with a particular object and/or drawing. Thus, users can view both an original comment, as well as any replies/responses to the comment (in a manner that enables the user to visually identify which replies/responses are associated with a particular comment and vice versa).

In view of the above, embodiments of the invention provide the ability to tag a particular point (e.g., point, region, object, 2D area, 3D area, etc.) in a drawing/model and attach any type of information to that tag (e.g., a comment, a file, a task, etc.). When a comment is attached, and the user selects the comment (e.g., in a comment viewing area), the drawing/model may scroll to the part of the drawing/model where the comment is located/attached. Such capability may be enabled via an API (application programming interface) (implemented in a drawing/CAD application) that enables attachment of entities/objects to a point (and/or navigation to that point). Such an API allows application other than the drawing/CAD application to retrieve, utilize, navigate to, etc. a comment and objects/entities associated with such a comment.

Accordingly, in view of the above, embodiments of the invention provide an enhanced level of feedback (via comments) of a drawing/graphic design that further enables search capabilities of such feedback across multiple platforms.

### Software Implementation Details

The above-description provides an overview of how an author may comment on a particular drawing/graphic design. To better understand such capabilities, embodiments of the invention may provide an API that allows users to create, modify, and retrieve/view comments and replies. Such an API may be referred to as a “comment API”, the details of which follow.

A comment may be stored in the form of a comment object which may be a JSON (JAVA™ Script Object Notation) which is a lightweight data-interchange format and is easy/fast for machines to parse and generate. A comment encapsulated in a comment object may have multiple replies and multiple levels of depth may be supported. Comments can be associated with an area or an object within a drawing and detail information such as coordinates or object identifiers may be embed into the comment object. In addition, an attachment (e.g., an image, video, or any other drawing file) may be embed into the comment and/or uploaded to a storage service on the cloud.

Comments may be inserted/posted using a POST command. The body of the comment contains a comment object (e.g., in JSON format). Any returned response may also be a comment object with auto-generated details (e.g., in JSON format). In this regard, a comment object for a response specifies/refers to the parent comment object to establish a link.

Comments may be updated using a PUT command.

A list of comments may be retrieved using a GET command based on a file or comment id. Replies may always be returned with a parent comment.

As described above, comments can have any attachments such as an image or video file, or another drawing file. An API may be used to POST a multi-part file to cloud storage. Such files may be stored in a separate location in cloud storage (e.g., within an “attachment” directory”). A returned response to the post may be XML (extensible markup language) containing the attachment id that can be embed in an “image” or “url” of the attachment section in the comment object. Posted files may be assigned appropriate MIME types so that the underlying application or browser can display it properly.

The comment object may have the following various sections:
Comment: that contains the actual comment text, date published/updated, status, index, id, etc.;
Privacy: with user identifiers to which the comment is addressed;
Attachment: with information about the attachments associated with a comment;
ObjectSet: that allows the user to associate the comment with a set of shapes, objects, or sheets in a drawing
Tag: that allows the user to associate any additional key-value pairs along with the comment;
Viewport: that allows the user to add 2D/3D viewport information (i.e., view information about the view/viewport of the drawing);
Parent: information about the parent object on which a comment is being posted;
Actor: information about the entity that initiated/posted the comment; and
Generator: information about the service/consumer application that posted the comment.

Most of the above sections are optional and a user can add/update any section as desired. Some of the sections may be automatically populated and do not require any user input (e.g., comment, parent, actor, and generator).

Each section of the comment object may contain the following fields:

Comment Section

Id: Id of the comment that may be auto generated when the user creates (e.g., POST) the comment. Any updates to the object are made using this id. A sample value is “a599b9e56c914c159fa939bdd520 dbec”.

Status: Status of the comment which may be open/closed.

Index: An auto generated sequence for a given entity id (e.g., “1-n”).

Published: Date the comment was published that may be timestamped in UTC (Coordinated Universal Time) (e.g., “2011-11-02T21:12:02.634Z”).

LayoutName: Name of the layout with an empty name indicating “MODEL SPACE”.

LayoutIndex: Index of the layout, if any.

Type: Type of comment (e.g., file, geometry, sheet, object, etc.).

Updated: Last update date on which the comment was updated.

Body: Any textual comment (e.g., “I liked this change of yours”).

Privacy Section (Array)

Name: Name of the user.

Id: User id.

Attachment Section (Array)

Id: Field of the associated attachment, if any (e.g., “772f1af0a8094bf38249cfbb3b0e8cc4”).

Name: attachment name.

Type: Mime-type (e.g., image/jpeg).

URL: URL of the original attachment. This can be any public URL, or the id received from an attachment API.

Image: URL of a generated thumbnail. URL of the original attachment.

The URL can be any public URL or the id received from an attachment API.

ObjectSet Section (Array)

Id: string of array Ids (e.g., [“12345”, “2322”].

Tags Section (Array)

Name: Name (e.g., “material”).

Value: Value (e.g., “iron”).

Viewport Section

Twod (array): Array of string (bounding box) (e.g., [“200”, “200”, “400”, “400”].

### ThreeD Subsection (3D Viewport Information)

Position: Camera position in world unit (x,y,z) that is an array of String (e.g., [“10.2”, “202”, “42”]).

Rotation: Camera rotation as a quaternion (x,y,z,w) that is an array of String (e.g., [“0”, “0.707”, “0”,“0.707”]).

Projection: Projection type with values such as perspective/orthographic.

FieldOfView: Whole vertical field of view in radians (from the top of the screen to the bottom of the screen).

OrthographicHeight: Whole vertical orthographic height in world units.

DistanceToOrbit: Distance to camera focus in world units.

AspectRatio: Width:Height (aspect ratio of world view and not of the screen).

Parent Section

Id: The id of the object being acted upon.

Version: Version of the parent object.

Name: Name.

Image: optional image.

Type: File/comment.

Actor Section

Id: The user id of the actor performing the comment.

Name: Full name of the actor as stored in the cloud at the time the comment is posted.

Image: Optional image href (hypertext reference) for the actor.

Type: The type for an actor (e.g., “user”).

Generator Section

Id: Consumer id of the generator performing the comment.

Name: Typically the service/application name (e.g., “AutoCAD”).

Image: Logo/Image associated with the application/service.

Type: Type of generator (usually “Consumer”).

### Workflow Overview

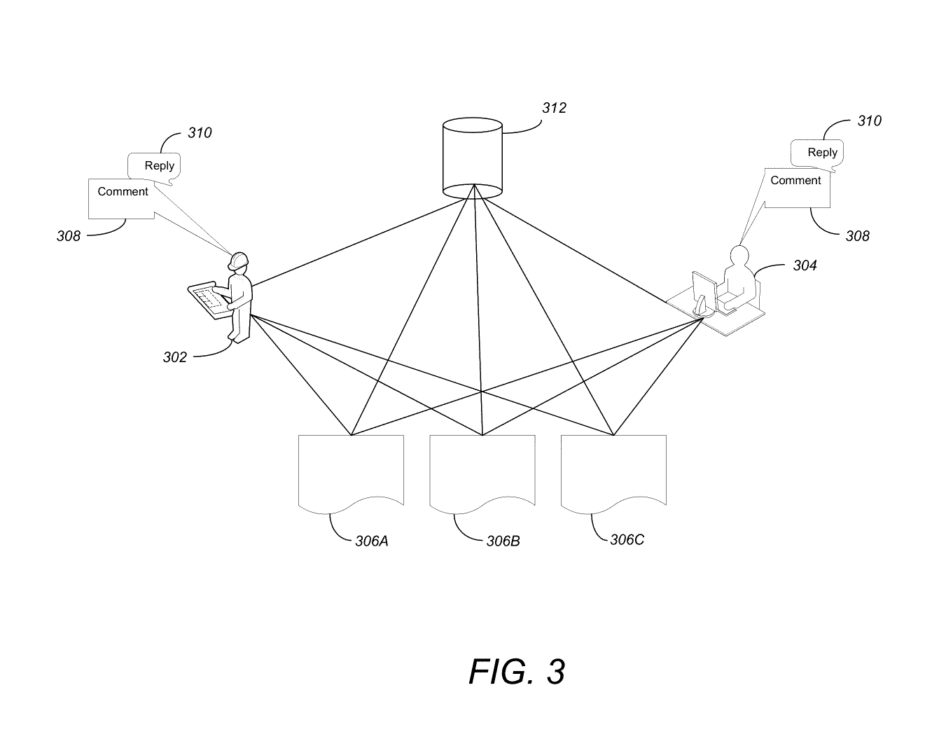

FIG. 3 illustrates the workflow for commenting on a drawing in accordance with one or more embodiments of the invention.

As illustrated users 302 (field worker [e.g., on a tablet computer]) and 304 (desktop CAD designer) (additional users may also be part of the workflow) may each separately and/or in collaboration create various design documents/drawings 306A, 306B, and 306C (collectively referred to as drawings 306). Such drawings 306 may be stored locally, on the cloud, or in a location accessible to the users 302 and 304. The users 302 and 304 may view the drawings 306 on their respective computing systems (e.g., tablet, desktop computer, mobile phone, personal digital assistant [PDA], etc.) and make comments 308 and/or replies to comments 310 with respect to the drawings 306. A comment object is created and identifies both the particular drawing 306 (and/or multiple drawings 306) as well as a particular location/object within the drawing 306 to which the comment 308 applies. The comments are stored in database 312 on the cloud or in an accessible location. The comments 308 and replies 310 provide an activity stream associated with the drawings 306 that enhance the feedback that is possible in the design/drawing environment.

### Logical Flow

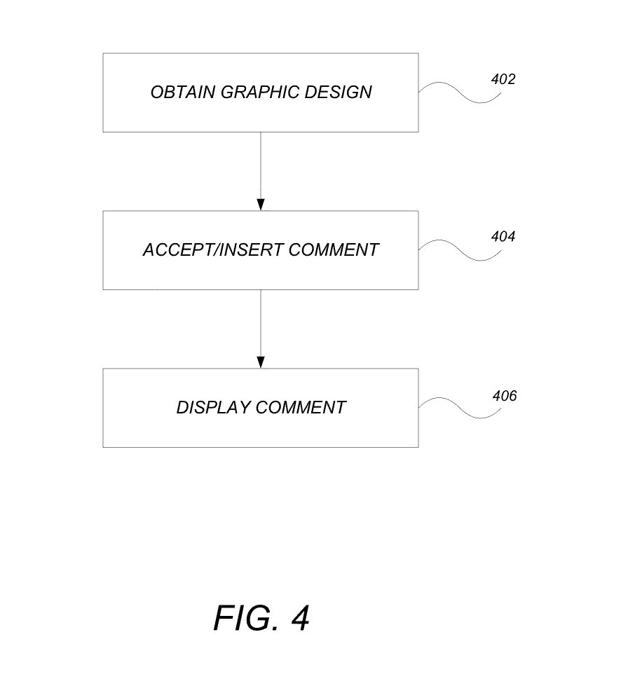

FIG. 4 illustrates the logical flow for comment on a graphic design in accordance with one or more embodiments of the invention.

At step 402 a graphic design/drawing (e.g., 2D or 3D) is obtained.

At step 404, a comment is inserted by/accepted from an author commenting on the graphic design. The comment includes contextual metadata (and may optionally include an attachment [to the comment and/or the drawing or location/object(s) in the drawing] such as a free-hand graphic, file, task, link, etc.). The contextual metadata includes an identification of a location in the graphic design (e.g., a list of object identifiers identifying objects in the design that the comment is bound to/associated with), a data and/or time the comment was accepted/inserted, an author identification, and searchable text. The contextual metadata may also include view information that can be used to restore a view of the graphic design. Such view information may be in the form of the object that is attached to the comment. For example, the object may be an (automatically captured [i.e., without additional user input]) digital image of an exact model view of the graphic design that exists at the time the comment was initially defined (i.e., an image of what the graphic design looked like at the time the comment was accepted). Such an image provides a useful construct to guarantee that a reviewer is able to see exactly the same image as the commenter. In this regard, the object may be an image capture (e.g., from a mobile device/camera) that illustrates the “as-is” state of a digital model. Such an image capture may be of the real-world implementation (e.g., a picture of the physical building construction site of the model) or may be a picture taken of the model from the display device.

Step 404 may also include the storing of the contextual metadata in a database that can be searched (e.g., across one and/or multiple drawing designs, projects, users, etc.) to locate a set of comments based on various search criteria. The search criteria may specify all comments entered by a specific individual/author based on the author identification, all comments about a specific design entity/object (i.e., in the drawing design), all designs having specific text in the searchable text, etc.

In addition, a reply to the comment from a user may be accepted/inserted and associated with the comment (thereby providing a mechanism for collaborative review). Such a collaborative review may be further provided using an activity stream where the contextual metadata is used to link the comment in the design drawing across different drawing systems (e.g., by using common object identifiers with information stored in the cloud).

At step 406, the comment is displayed.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for commenting on a graphic design comprising:
(A) obtaining the graphic design,
(B) accepting a comment from an author commenting on the graphic design, wherein the comment comprises contextual metadata comprising:
(i) an identification of a location in the graphic design;
(ii) a date and time the comment was accepted,
(iii) an author identification; and
(iv) searchable text; and
(C) displaying the comment.

2. The computer-implemented method of claim 1, wherein:
the contextual metadata further comprises view information; and
the view information is used to restore a view of the graphic design.

3. The computer-implemented method of claim 1, wherein the identification of the location comprises a list of object identifiers identifying objects in the graphic design that the comment is bound to.

4. The computer-implemented method of claim 1, further comprising:
storing the contextual metadata in a database; and
searching the database to locate a set of comments based on search criteria.

5. The computer-implemented method of claim 4, wherein the search criteria is for all comments entered by a specific individual based on the author identification.

6. The computer-implemented method of claim 4, wherein the search is performed across multiple drawing designs.

7. The computer-implemented method of claim 4, wherein the search criteria is for all comments about a specific design entity.

8. The computer-implemented method of claim 4, wherein the search criteria is for all designs having specific text in the contextual information.

9. The computer-implemented method of claim 1, further comprising attaching an object to the comment.

10. The computer-implemented method of claim 9, wherein the object comprises a free-hand graphic.

11. The computer-implemented method of claim 9, wherein the object comprises an automatically captured digital image of an exact model view of the graphic design that exists at the time the comment is initially defined.

12. The computer-implemented method of claim 9, wherein the object comprises an image capture from a mobile device that illustrates an “as-is” state of the graphic design.

13. The computer-implemented method of claim 1 further comprising:
accepting a reply to the comment from a user; and
associating the reply with the comment, thereby providing a mechanism for collaborative review.

14. The computer-implemented method of claim 1, further comprising:
utilizing the contextual metadata to link the comment in the design drawing across different drawing systems.

15. A computer readable storage medium encoded with computer program instructions which when accessed by a computer cause the computer to load the program instructions to a memory therein creating a special purpose data structure causing the computer to operate as a specially programmed computer, executing a method of commenting on a graphic design, the method comprising:
(A) obtaining, in the specially programmed computer, a graphic design;
(B) accepting, in the specially programmed computer, a comment from an author commenting on the graphic design, wherein the comment comprises contextual metadata comprising:
(i) an identification of a location in the graphic design;
(ii) a date and time the comment was accepted,
(iii) an author identification; and
(iv) searchable text; and
(C) displaying, via the specially programmed computer, the comment.

16. The computer readable storage medium of claim 15, wherein:
the contextual metadata further comprises view information; and
the view information is used to restore a view of the graphic design.

17. The computer readable storage medium of claim 15, wherein the identification of the location comprises a list of object identifiers identifying objects in the graphic design that the comment is bound to.

18. The computer readable storage medium of claim 15, further comprising:
storing the contextual metadata in a database; and
searching the database to locate a set of comments based on search criteria.

19. The computer readable storage medium of claim 18, wherein the search criteria is for all comments entered by a specific individual based on the author identification.

20. The computer readable storage medium of claim 18, wherein the search is performed across multiple drawing designs.

21. The computer readable storage medium of claim 18, wherein the search criteria is for all comments about a specific design entity.

22. The computer readable storage medium of claim 18, wherein the search criteria is for all designs having specific text in the contextual information.

23. The computer readable storage medium of claim 15, further comprising attaching, in the specially programmed computer, an object to the comment.

24. The computer readable storage medium of claim 23, wherein the object comprises a free-hand graphic.

25. The computer readable storage medium of claim 23, wherein the object comprises an automatically captured digital image of an exact model view of the graphic design that exists at the time the comment is initially defined.

26. The computer readable storage medium of claim 23, wherein the object comprises an image capture from a mobile device that illustrates an “as-is” state of the graphic design.

27. The computer readable storage medium of claim 15 further comprising:
accepting a reply to the comment from a user; and
associating the reply with the comment, thereby providing a mechanism for collaborative review.

28. The computer readable storage medium of claim 15, further comprising:
utilizing the contextual metadata to link the comment in the design drawing across different drawing systems.
